(19) United States
(12) Patent Application Publication
(10) Pub. No.: US 2015/0299437 A1
(43) Pub. Date: Oct. 22, 2015

(54) PREPARATION OF RUBBER REINFORCED WITH GRAPHENE AND CARBON NANOTUBES AND FUNCTIONALIZED ELASTOMERS AND TIRE WITH COMPONENT

(71) Applicant: The Goodyear Tire & Rubber Company, Akron, OH (US)

(72) Inventors: Ralf Mruk, Lipperscheid (LU); Annette Lechtenboehmer, Ettelbruck (LU); Klaus Unseld, Luxembourg (LU); Claude Ernest Felix Boes, Erpeldange (LU); Frederic Gerard Auguste Siffer, Petite Rossell (FR); Ling Du, Fairlawn, OH (US); Robert Fokko Roskamp, Trier (DE); Leena Nebhani, Copley, OH (US)

(73) Assignee: The Goodyear Tire & Rubber Company, Akron, OH (US)

(21) Appl. No.: 14/253,908

(22) Filed: Apr. 16, 2014

(51) Int. Cl. C08L 9/00; C08L 9/06

(52) U.S. Cl. CPC C08L 9/00; C08L 9/06

(57) ABSTRACT

The invention relates to functionalization of diene-based elastomers with end-chain or in-chain functional groups to promote good dispersion of graphene and carbon nanotubes, and enhance strong interaction between elastomers and graphene and carbon nanotubes. This invention also relates to preparation of rubber reinforced with at least one of graphene and carbon nanotubes with functionalized diene-based elastomer and tire with component thereof.

### FIELD OF INVENTION

The invention relates to functionalization of diene-based elastomers with chain-end or with in-chain functional groups to promote good dispersion of graphene and carbon nanotubes, and enhance strong interaction between elastomers and graphene and carbon nanotubes. This invention also relates to preparation of rubber reinforced with at least one of graphene and carbon nanotubes with the functionalized diene-based elastomer and tire with component thereof.

### BACKGROUND OF THE INVENTION

Rubber compositions containing diene-based elastomers often contain reinforcing fillers such as for example rubber reinforcing carbon black and precipitated silica together with a coupling agent for the precipitated silica. Rubber tires may contain at least one component comprised of such rubber composition.

Sometimes it may be desirable to provide a rubber composition containing an alternative reinforcing filler.

For example, such additional, or alternative, reinforcing filler may be in a form of graphene or carbon nanotubes.

For this invention, promotion of interfacial bonding of graphene and carbon nanotubes to diene-based elastomers is desired.

Graphene and carbon nanotubes may exhibit exceptional mechanical and electrical properties that make them very interesting for the use in rubber compositions including for tire components. However, in order to benefit from the advantages of graphene or carbon nanotubes, it is important for a high level of their dispersion in their associated rubber be promoted. Such dispersion is generally a challenge because graphene sheets tend to stack together, exfoliated graphene platelets tend to agglomerate and carbon nanotubes tend to from entangled aggregates to thereby form restricted dispersions in the rubber composition and thereby weak interfacial interactions with diene-based elastomers in the rubber composition.

For this invention it is desired to promote interfacial bonding of the graphene and carbon nanotubes to various diene-based elastomers.

To promote such interfacial bonding, it is proposed that functionalized diene-based elastomers with conjugated carbon-to-carbon double bond containing functional groups be used which will promote a pi-pi (π-π) network interaction with the graphene or carbon nanotubes.

It is proposed that such conjugated carbon-to-carbon double bond containing functional groups may be either pendent to the elastomeric polymer chain to form in-chain functionalized diene-based elastomers, or be end-chain positioned on, or attached to, an end of the elastomeric polymer chain to form end-chain functionalized diene-based elastomers.

In one embodiment, it is proposed that the conjugated functional groups may be attached to the chain end of diene-based elastomer to form end-functionalized elastomers after polymerization of the monomers by use of polymerization terminating agents. Representative examples of such functional groups are, for example, anthracene, alkyl (e.g. methyl) anthracene, phenanthrene, alkyl (e.g. methyl) phenanthrene, pyrene, alkyl (e.g. methyl) pyrene, chrysene, alkyl (e.g. methyl) chrysene and phenylethynyl-oligomers. The polymerization terminating agents for such purpose may be, for example, 9-halo (e.g. chloro)-anthracene, 9-halo (e.g. chloro)-alkyl (e.g. methyl) anthracene; halo (e.g. bromo)-phenanthrene, 2-halo (e.g. bromo) halo (e.g. methyl)-phenanthrene; halo (e.g. bromo)-pyrene, 1-halo (e.g. bromo) alkyl (e.g. methyl) pyrene, halo (e.g. bromo) chrysene, halo (e.g. bromo) alkyl (e.g. methyl) chrysene, and halo (e.g. bromo)-phenylethynyl-oligomers, which can terminate the polymerization by end-capping the living elastomer chain resulting in the formation of an end-functionalized elastomer.

Alternatively, the conjugated functional groups can be attached to polybutadiene and styrene/butadiene elastomers as pendent groups through a thioether linkage to pendent vinyl groups on the polybutadiene component of the elastomer chain by post polymerization treatment of an elastomer to form in-chain functionalized elastomers. One benefit of in-chain functionalized diene-based elastomers is it can have more than one pendent functional group, such as from 1 to 10, or alternately from 1 to 4, to promote stronger interaction (e.g. more complex network) between polymer and graphene or carbon nanotubes as compared to the aforesaid singular end chain functional group for an elastomer polymer chain. It is proposed that the functional groups for such purpose may be the aforesaid anthracene, alkyl (e.g. methyl) anthracene, phenanthrene, alkyl (e.g. methyl) phenanthrene, pyrene, alkyl (e.g. methyl) pyrene, chrysene, alkyl (e.g. methyl) chrysene, and phenylethynyl-oligomers.

Historically, graphene may be provided in a form of exfoliated graphite platelets, referred to herein as graphene, from exfoliated intercalated graphite (exfoliated intercalated graphite in a stacked platelet form with internal galleries between the graphite platelets) which may be exfoliated, for example, chemically or thermally. The graphene has been suggested, for example, for use in rubber compositions for various tire components. For example, and not intended to be limiting, see U.S. Pat. Nos. 7,479,516, 7,224,407 and 6,892,771 and U.S. Patent Application No. 2006/0229404.

Such graphene (exfoliated graphite platelets) are typically irregularly shaped platelets and nano-sized in a sense that they have an average thickness in a range of from about 1 nm to about 5 nm (nanometers) and an average lateral dimension in a range of from about 0.1 to about 1 micrometer (e.g. in a range of from about 0.01 to about 1 square micrometers which is envisioned to have, for example, an average surface area per gram in a range of from about 20 to about 800 square meters per gram).

Historically, carbon nanotubes or graphene have heretofore been suggested for inclusion in rubber compositions, including tire treads, for various purposes. For example, and not intended to be limiting, see Patent Publications: U.S. Pat. No. 6,476,154, US 2006/0061011, US 2010/0078194, US 2011/0146859, WO2003/060002, DE 102007056689, JP 2009/046547, KR 100635604 and KR 2005027415.

Such carbon nanotubes are nano-sized particles in a sense of having, for example, an average diameter or thickness in a range of from about 1 nm to about 100 nm and an average L/D (length to diameter or thickness dimension, or ratio) in a range of from about 10/1 to about 10,000/1.

Such carbon nanotubes may be, for example, a product of gaseous carbon-containing compound such as for example, at least one of acetylene and ethanol, usually contained in nitrogen or hydrogen passed through or over a heated catalyst (e.g. heated to about 700° C.) of metal nanoparticles. Carbon deposited on the metallic nanoparticles in a form of the carbon nanotubes is recovered.

In the description of this invention, the term “phr” is used to designate parts by weight of a material per 100 parts by weight of elastomer. The terms “rubber” and “elastomer” may be used interchangeably unless otherwise indicated. The terms “vulcanized” and “cured” may be used interchangeably, as well as “unvulcanized” or “uncured”, unless otherwise indicated.

### SUMMARY AND PRACTICE OF THE INVENTION

In accordance with this invention, a method of preparing a rubber composition containing reinforcing filler comprised of at least one of graphene and carbon nanotubes is comprised of, based upon parts by weight per 100 parts by weight rubber (phr):

(A) Blending in at least one sequential preparatory mixing step at a temperature in a range of from about 60° C. to about 170° C., alternately from about 90° C. to about 170° C.,
(1) 100 phr of elastomers comprised of:
   (a) at least one diene-based elastomer, and
   (b) at least one functionalized diene-based elastomer comprised of at least one of cis 1,4-polybutadiene rubber and styrene/butadiene rubber containing functional groups positioned at least one of:
      (i) an end of the elastomer's polymeric chain as an end-chain functional group, and
      (ii) within the elastomer's polymeric chain as pendent functional groups by a thioether linkage to the polybutadiene portion or polyisoprene portion of the elastomer;
   wherein said functional groups are comprised of at least one of anthracene, alkyl (e.g. methyl) anthracene, phenanthrene, alkyl (e.g. methyl) phenanthrene, pyrene, alkyl (e.g. methyl) pyrene, chrysene, alkyl (e.g. methyl) chrysene and phenylethynyl-oligomers;
(2) about 30 to about 120, alternately from about 50 to about 110, phr of rubber reinforcing filler comprised of about 0.5 to about 30, alternately from about 1 to about 10 phr of at least one of graphene and carbon nanotubes, and
   (a) rubber reinforcing carbon black, or
   (b) combination of rubber reinforcing carbon black and precipitated silica (synthetic amorphous precipitated silica), together with silica coupler for the precipitated silica having a moiety reactive with hydroxyl groups (e.g. silanol groups) on the precipitated silica and another, different, moiety interactive with said diene-based elastomer(s), and

(B) Blending in a final mixing step (at a temperature in a range of form about 60° C. to about 120° C., alternately from about 70° C. to about 110° C. sulfur curatives comprised of sulfur and at least one sulfur cure accelerator.

In practice, the aforesaid diene-based elastomer is comprised of at least one of polymers of at least one of isoprene and 1,3-butadiene and styrene with at least one of isoprene and 1,3-butadiene monomers.

In practice, said functionalized diene-based elastomers are comprised of at least one of the said cis 1,4-polybutadiene, styrene/butadiene and polyisoprene elastomers which contain vinyl 1,2-pendent groups from the polybutadiene or isoprene portion of the elastomers available to react with the said functional groups to form pendent functional groups on the elastomer's polymer chain.

In practice, said alkyl groups of said functional groups are desirably methyl groups.

In practice said functionalized diene-based elastomers are desirably selected from functionalized cis 1,4-polybutadiene and styrene/butadiene rubbers.

In further accordance with this invention, a rubber composition is provided as prepared by such method.

In additional accordance with this invention, a rubber composition is provided comprised of, based on parts by weight per parts by weight rubber (phr):

(A) 100 phr of elastomers comprised of:
(1) at least one diene-based elastomer, and
(2) at least one functionalized diene-based elastomer comprised of at least one of cis 1,4-polybutadiene rubber, styrene/butadiene rubber and polyisoprene rubber containing functional groups positioned at least one of:
   (a) an end of the elastomer's polymeric chain as end chain functional groups, and
   (b) within the elastomer's polymeric chain as a pendent functional group by a thioether linkage to a polybutadiene or polyisoprene component of the elastomer;
wherein said functional groups are comprised of at least one of anthracene, alkyl (e.g. methyl anthracene), phenanthrene, alkyl (e.g. methyl phenanthrene), pyrene, alkyl (e.g. methyl pyrene), chrysene, alkyl (e.g. methyl chrysene) and phenylethynyl-oligomers;

(B) about 30 to about 120, alternately from about 50 to about 110, phr of rubber reinforcing filler comprised of about 0.5 to about 30, alternately from about 1 to about 10 phr of at least one of graphene and carbon nanotubes, and
(1) rubber reinforcing carbon black, or
(2) combination of rubber reinforcing carbon black and precipitated silica (synthetic amorphous precipitated silica), together with silica coupler for the precipitated silica having a moiety reactive with hydroxyl groups (e.g. silanol groups) on the precipitated silica and another, different, moiety interactive with said diene-based elastomer(s).

In practice, said alkyl groups of said functional groups are desirably methyl groups.

In practice said functionalized diene-based elastomers are desirably selected from functionalized cis 1,4-polybutadiene and styrene/butadiene rubbers.

In additional practice of the invention, a tire is provided having at least one component comprised of such rubber composition. Such component may, for example and not intended to be limiting, be at least one of tire tread, chafer, electrically conductive chimney, and tire tread base.

In practice, the end-chain functionalized cis 1,4-polybutadiene rubber, styrene/butadiene rubber and polyisoprene rubber may be prepared by terminating the polymerization of the monomers with a polymerization terminating agent which contains said functional group to end-functionalize one end of the polymer chain. In this manner, then, one end of the polymer chain would be functionalized.

Alternatively, in practice, the in-chain functionalized cis 1,4-polybutadiene rubber, styrene/butadiene rubber and polyisoprene rubber may be prepared by treating the elastomer (an already prepared elastomer) with an aforesaid functional group to functionalize the elastomer's polymer chain by thiol-ene reaction at pendent vinyl 1,2-groups contained on the polybutadiene portion or polyisoprene portion of the elastomer. In this manner, then, the polymer chain would be functionalized along the polymer chain itself instead of being end-functionalized.

For a further understanding of the invention, drawings are provided.

### BRIEF DESCRIPTION OF DRAWINGS

FIGS. 1 through 6 are provided to illustrate functionalized elastomers (elastomers containing functional groups) as FIG. 1; polymerization terminating agents for preparing end functionalized elastomers as FIG. 2; in-chain functionalized elastomers with pendent functional groups as FIG. 3; a reaction mechanism for in-chain functionalization of envisioned styrene/butadiene elastomers by thiol-ene reaction as FIG. 4; examples of in-chain functionalized envisioned styrene/butadiene rubber with pendent functional groups as FIG. 5; and examples of chemical structures of monomers for in-chain functionalization of diene-based elastomers through a thiol-ene reaction as FIG. 6.

### IN THE DRAWINGS

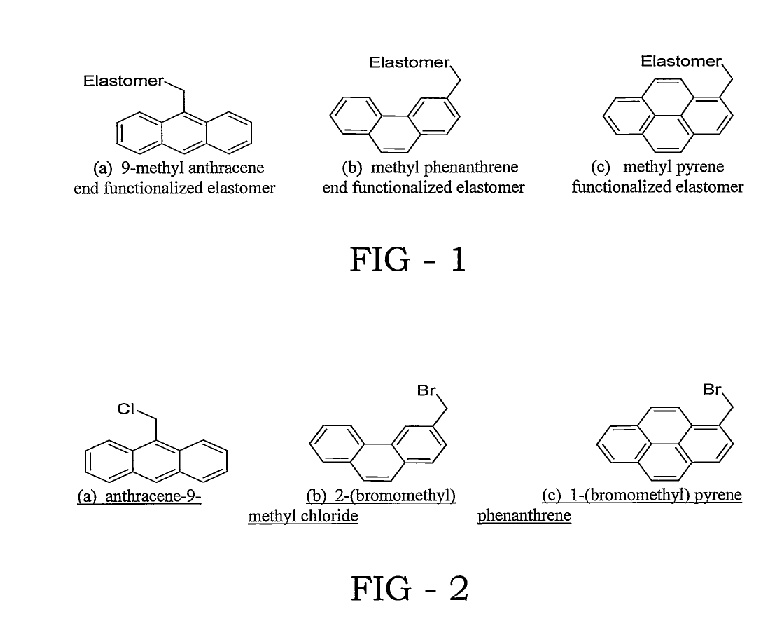

FIG. 1 illustrates end-functionalized elastomers where one end of the elastomer is provided with a functional group represented by a general formula of FIG. 1 where the functional groups are provided as anthracene, phenanthrene and pyrene functional groups as:

(a) 9-methyl anthracene end functionalized elastomer,

(b) methyl phenanthrene end functionalized elastomer, and

(c) methyl pyrene end functionalized elastomer.

FIG. 2 illustrates polymerization terminating agents for preparing such exemplary end-chain functionalized elastomers of FIG. 1 as

(a) anthracene-9-pyrene methyl chloride,

(b) 2-(bromomethyl) phenanthrene, and

(c) 1-(bromomethyl) phenanthrene.

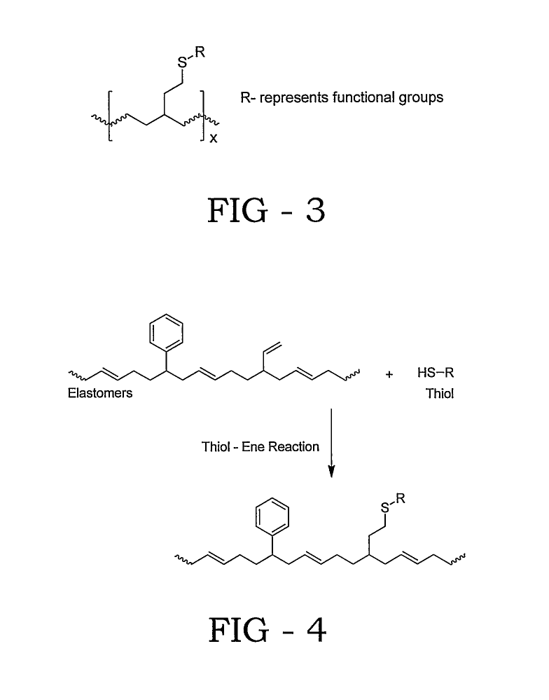

FIG. 3 illustrates general chemical structures of in-chain functionalized elastomers as envisioned elastomers such as polybutadiene or styrene/polybutadiene elastomers which are in-chain functionalized with said functional groups composed of a thiol group to a pendent vinyl 1,2-group on the polybutadiene portion or polyisoprene portion of the elastomer, such as anthracene, phenanthrene and pyrene groups where R represents a pendent functional group associated with a polybutadiene portion of the elastomer's polymer chain through thioether linkage achieved, and x represents the average number of in-chain functional groups as being, for example, in a range of from about 1 to about 10, alternately from about 1 to about 4.

The functional groups represented by R may be, for example, anthracene, 9-alkyl (for example, a methyl anthracene), phenanthrene, 3-alkyl (for example a methyl phenanthrene), pyrene, alkyl (for example a methyl) pyrene), chrysene 5-alkyl (for example a methyl crysene), and one or more of phenylethynyl-oligomers, benzene 4-[2-(9-anthracenenyl)ethynyl-, benzene 4-[2-[4-(2-phenylethynyl)phenyl]ethynyl]- and benzenemethyl 4-[2-[4-(2-phenylethynyl)phenyl]ethynyl]- and oligomers.

FIG. 4 illustrates an in-chain functionalization of the an envisioned elastomer such as polybutadiene, styrene/butadiene and polyisoprene elastomers by a thiol-ene reaction mechanism, namely a reaction mechanism of synthesis of in-chain functionalized elastomer by a thiol-ene reaction during post polymerization treatment of the elastomer where R represents the functional groups as described in for FIG. 3.

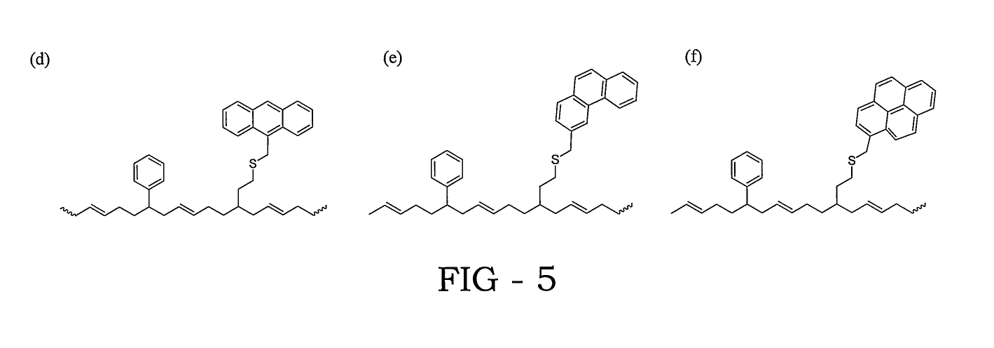

FIG. 5 illustrates three examples of in-chain functionalized rubbers envisioned as styrene/butadiene elastomers with pendent functional groups referred to as FIG. 5 (d), (e) and (f) where the examples of the in-chain functionalized elastomers are envisioned as:

(d) 9-methyl thiol anthracene in-chain functionalized styrene/butadiene elastomers,

(e) 3-methyl thiol phenanthrene in-chain functionalized styrene/butadiene elastomers, and

(f) 1-methyl thiol pyrene in-chain functionalized styrene/butadiene elastomers.

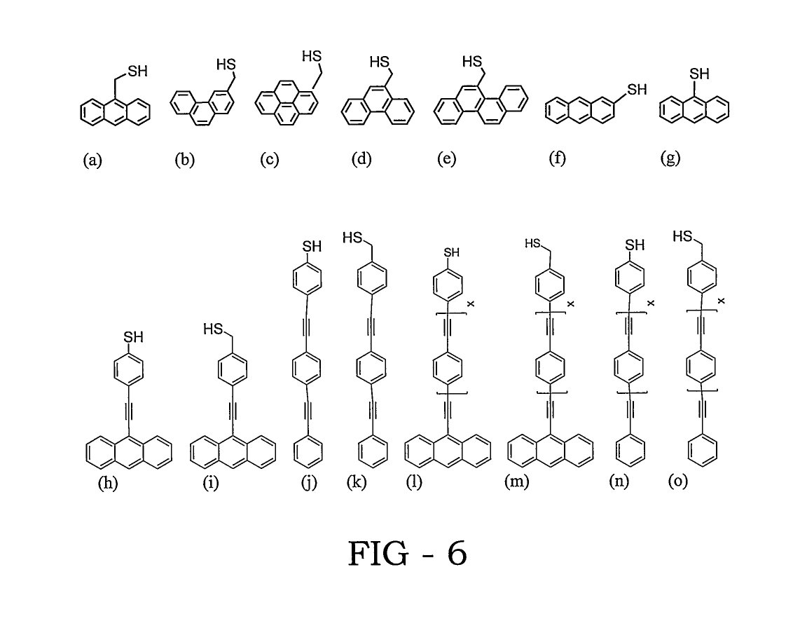

FIG. 6 illustrates of chemical structures of monomers for use in-chain functionalization of the diene-based elastomers through a thiol-ene reaction shown as (a) through (o) of FIG. 6.

Representative of such examples of the chemical structures illustrated in FIG. 6 are referred to herein as:

(a) 9-methylthiol anthracene,

(b) 3-methylthiol phenanthrene,

(c) 1-methylthiol pyrene,

(d) 9-methylthiol phenanthrene,

(e) 5-methylthiol chrysene,

(f) 2-thiol-anthracene,

(g) 9-thiol-anthracene,

(h) benzenethiol 4-[2-(9-anthracenenyl)ethynyl-,

(i) benzenemethanethiol 4-[2-(9-anthracenenyl)ethynyl-,

(j) benzenethiol 4-[2-[4-(2-phenylethynyl)phenyl]ethynyl]-,

(k) benzenemethanethiol 4-[2-[4-(2-phenylethynyl)phenyl]ethynyl]-,

(l) benzenethiol 4-[2-(9-anthracenenyl)ethynyl-oligomer,

(m) benzenemethanethiol 4-[2-(9-anthracenenyl)ethynyl-oligomer,

(n) benzenethiol 4-[2-[4-(2-phenylethynyl)phenyl]ethynyl]-oligomer, and

(o) benzenemethanethiol 4-[2-[4-(2-phenylethynyl)phenyl]ethynyl]-oligomer.

For FIG. 6, x is a repeat unit of phenylethynyl, which can be, for example, from 1 to 20, alternately from 1 to 5.

In one embodiment, said graphene (exfoliated graphene platelets) have an average thickness in a range of from about 1 nm to about 5 nm (nanometers) and an average lateral dimension in a range of from about 0.1 to about 1 micrometer.

In one embodiment, said exfoliated graphene platelets have an average surface area per gram in a range of from about 20 to about 800 square meters per gram.

In one embodiment, said carbon nanotubes have an average diameter in a range of from about 5 to about 20 nanometers (nm) and an L/D ratio in a range of from about 100 to about 1000.

In practice, various diene-based elastomers may be used for the rubber composition such as, for example, polymers and copolymers comprised of at least one monomer comprised of at least one of isoprene and 1,3-butadiene and from styrene copolymerized with at least one of isoprene and 1,3-butadiene.

Representative of such conjugated diene-based elastomers are, for example, comprised of at least one of cis 1,4-polyisoprene (natural and synthetic), cis 1,4-polybutadiene, styrene/butadiene copolymers (aqueous emulsion polymerization prepared and organic solvent solution polymerization prepared), medium vinyl polybutadiene having a vinyl 1,2-content in a range of about 15 to about 90 percent, isoprene/butadiene copolymers, styrene/isoprene/butadiene terpolymers. Tin coupled elastomers may also be used, such as, for example, tin coupled organic solution polymerization prepared styrene/butadiene co-polymers, isoprene/butadiene copolymers, styrene/isoprene copolymers, polybutadiene and styrene/isoprene/butadiene terpolymers.

In one aspect, the conjugated diene-based elastomer may be an elastomer such as, for example, styrene/butadiene copolymer containing at least one functional group reactive with hydroxyl groups on a precipitated silica such as, for example, comprised of at least one of siloxy, amine and imine groups.

Commonly employed synthetic amorphous silica, or siliceous pigments, used in rubber compounding applications can be used as the silica in this invention, including precipitated siliceous pigments and fumed (pyrogenic) silica wherein aggregates of precipitated silicas are usually preferred.

The precipitated silica employed in this invention are typically aggregates obtained by the acidification of a soluble silicate, e.g., sodium silicate and may include coprecipitated silica and a minor amount of aluminum.

Such silicas might usually be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 309 (1938), as well as ASTM D5604 for precipitated silica.

The silica may also be typically characterized by having a dibutylphthalate (DBP) absorption value in a range of about 50 to about 400 cc/100 g, and more usually about 100 to about 300 cc/100 g (ASTM D2414).

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165MP and Zeosil 165GR, silicas from Degussa AG with, for example, designations VN2 and VN3, as well as other grades of silica, particularly precipitated silicas, which can be used for elastomer reinforcement.

Various coupling agents, as previously described, may be used if desired to aid in coupling the silica (e.g. precipitated silica with hydroxyl groups on its surface), as well as interacting with the aforesaid functionalized carbon nanotubes.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing fillers materials such as, for example, the aforementioned rubber reinforcing carbon black and precipitated silica. As known to those skilled in the art, depending on the intended use of the sulfur vulcanizable and sulfur vulcanized material (rubbers), the additives mentioned above are selected and commonly used in conventional amounts.

Typical amounts of tackifier resins, if used, may, for example, comprise about 0.5 to about 10 phr, usually about 1 to about 5 phr. Typical amounts of processing aids, if used, may comprise, for example from about 1 to about 50 phr. Such processing aids can include, for example and where appropriate, aromatic, napthenic, and/or paraffinic processing oils. Typical amounts of antioxidants where used may comprise, for example, about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants, where used, may comprise for example about 1 to 5 phr. Typical amounts of fatty acids, if used, which can include stearic acid and combinations of stearic acid with one or more of palmitic acid oleic acid and may comprise, for example, from about 0.5 to about 3 phr. Typical amounts of zinc oxide may comprise, for example, from about 1 to about 10 phr. Typical amounts of waxes, such as for example microcrystalline waxes, where used, may comprise, for example, from about 1 to about 5 phr. Typical amounts of peptizers, if used, may comprise, for example, from about 0.1 to about 1 phr.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents may be used, for example, in an amount ranging from about 0.5 to about 4 phr, or even, in some circumstances, up to about 8 phr.

Sulfur vulcanization accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging, for example, from about 0.5 to about 4, alternately about 0.8 to about 1.5 phr. In another embodiment, combinations of a primary and a secondary accelerator might be used with the secondary accelerator, where used, being usually used in smaller amounts (for example about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used, for example, which are not affected by normal processing temperatures but produce a satisfactory cure at ordinary vulcanization temperatures. Vulcanization retarders might also be used, where desired or appropriate. Suitable types of accelerators that may be used in the present invention may be, for example, amines, disulfides, guanidines, thioureas, thiazoles, thiurams, sulfenamides, dithiocarbamates and xanthates. Preferably, the primary accelerator is a sulfenamide. If a second accelerator is used, the secondary accelerator may be, for example, a guanidine, dithiocarbamate or thiuram compound.

The presence and relative amounts of the above additives are not considered to be an aspect of the present invention, unless otherwise indicated herein.

The mixing of the rubber composition can be accomplished by methods known to those having skill in the rubber mixing art. For example, as indicated, the ingredients are typically mixed in at least two stages, namely, at least one non-productive stage followed by a productive mix stage. The final curatives (e.g. sulfur and sulfur vulcanization accelerators) are typically mixed in the final stage which is conventionally called the “productive” mix stage in which the mixing typically occurs at a temperature, or ultimate temperature, lower than the mix temperature(s) than the preceding non-productive mix stage(s). The rubber, and reinforcing fillers, including the exfoliated graphene platelets and alternative additional reinforcing fillers such as, for example precipitated silica and rubber reinforcing carbon black mixed in one or more non-productive mix stages. The terms “non-productive” and “productive” mix stages are well known to those having skill in the rubber mixing art.

While various embodiments are disclosed herein for practicing the invention, it will be apparent to those skilled in this art that various changes and modifications may be made therein without departing from the spirit or scope of the invention.

What is claimed is:

1. A method of preparing rubber composition containing reinforcing filler comprised of at least one of graphene and carbon nanotubes comprised of, based upon parts by weight per 100 parts by weight rubber (phr):
(A) Blending in at least one sequential preparatory mixing step:
(1) 100 phr of elastomers comprised of:
(a) at least one diene-based elastomer, and
(b) at least one functionalized diene-based elastomer comprised of at least one of cis 1,4-polybutadiene rubber, styrene/butadiene and cis 1,4-polyisoprene rubber containing functional groups positioned at least one of:
(i) an end of the elastomer's polymeric chain as end chain functional groups, and
(ii) within the elastomer's polymeric chain as pendent functional groups
(iii) within the elastomer's polymeric chain as pendent functional groups by a thioether linkage to the polybutadiene portion or polyisoporene portion of the elastomer;
wherein said functional groups are comprised of at least one of anthracene, alkyl anthracene, phenanthrene, alkyl phenanthrene, pyrene, alkyl pyrene, chrysene, alkyl chrysene and phenylethynyl-oligomers;
(2) about 30 to about 120 phr of rubber reinforcing filler comprised of about 0.5 to about 30 phr of at least one of graphene and carbon nanotubes, and
(a) rubber reinforcing carbon black, or
(b) combination of rubber reinforcing carbon black and precipitated silica together with silica coupler for the precipitated silica having a moiety reactive with hydroxyl groups on the precipitated silica and another, different, moiety interactive with said diene-based elastomer(s), and
(B) Blending in a final mixing step sulfur curatives comprised of sulfur and at least one sulfur cure accelerator.

2. The method of claim 1 wherein diene-based elastomer is comprised of at least one of polymers of at least one of isoprene and 1,3-butadiene and polymers of styrene with at least one of isoprene and 1,3-butadiene monomers.

3. The method of claim 1 wherein said functionalized diene-based elastomers are comprised of at least one of cis 1,4-polybutadiene, styrene/butadiene and polyisoprene elastomers which contain vinyl 1,2-pendent groups from the polybutadiene or isoprene portion of the elastomers available to react with the said functional groups resulting in an in-chain functionalized polymer chain.

4. The method of claim 1 wherein said alkyl group of said functional groups are methyl groups.

5. The method of claim 1 wherein the functionalized elastomer is an end-chain functionalized cis 1,4-polybutadiene rubber, styrene/butadiene rubber and cis 1,4-polyisoprene rubber is prepared by terminating the polymerization of the monomers with a polymerization terminating agent which contains said functional group to end-functionalize one end of the polymer chain.

6. The method of claim 1 wherein the functionalized elastomer is an in-chain functionalized cis 1,4-polybutadiene rubber, styrene/butadiene rubber and cis 1,4-polyhisoprene rubber is prepared by treating the elastomer with said functional group to functionalize the elastomer's polymer chain by reaction of a thiol group with pendent vinyl 1,2-groups contained on the polybutadiene or polyisoprene portion of the elastomer.

7. The method of claim 6 wherein said functional group used for in-chain functionalization of the elastomers through thiol-ene reaction are comprised of at least one of:
(A) 9-methylthiol anthracene,
(B) 3-methylthiol phenanthrene,
(C) 1-methylthiol pyrene,
(D) 9-methylthiol phenanthrene,
(E) 5-methylthiol chrysene,
(F) 2-thiol-anthracene,
(G) 9-thiol-anthracene,
(H) benzenethiol 4-[2-(9-anthracenenyl)ethynyl-,
(I) benzenemethanethiol 4-[2-(9-anthracenenyl)ethynyl-,
(J) benzenethiol 4-[2-[4-(2-phenylethynyl)phenyl]ethynyl]-,
(K) benzenemethanethiol 4-[2-[4-(2-phenylethynyl)phenyl]ethynyl]-,
(L) benzenethiol 4-[2-(9-anthracenenyl)ethynyl-oligomer.
(M) benzenemethanethiol 4-[2-(9-anthracenenyl)ethynyl-oligomer,
(N) benzenethiol 4-[2-[4-(2-phenylethynyl)phenyl]ethynyl]-oligomer, and
(O) benzenemethanethiol 4-[2-[4-(2-phenylethynyl)phenyl]ethynyl]-oligomer.

8. A rubber composition prepared by the method of claim 1.

9. A rubber composition comprised of, based on parts by weight per parts by weight rubber (phr):
(A) 100 phr of elastomers comprised of:
(1) at least one diene-based elastomer, and
(2) at least one functionalized diene-based elastomer comprised of at least one of cis 1,4-polybutadiene rubber, styrene/butadiene rubber and cis 1,4-polyisoprene rubber containing functional groups positioned at least one of:
(a) an end of the elastomer's polymeric chain as end chain functional groups, and
(b) within the elastomer's polymeric chain as a pendent functional group by a thioether linkage to a polybutadiene component of the elastomer
wherein said functional groups are comprised of at least one of anthracene, alkyl anthracene, phenanthrene, alkyl phenanthrene, pyrene, alkyl pyrene, chrysene, alkyl chrysene and phenylethynyl-oligomers;
(B) about 30 to about 120 phr of rubber reinforcing filler comprised of about 0.5 to about 30 phr of at least one of graphene and carbon nanotubes, and
(1) rubber reinforcing carbon black, or
(2) combination of rubber reinforcing carbon black and precipitated silica together with silica coupler for the precipitated silica having a moiety reactive with hydroxyl groups on the precipitated silica and another, different, moiety interactive with said diene-based elastomer(s).

10. The rubber composition of claim 9 wherein said diene-based elastomer is comprised of at least one of polymers of at least one of isoprene and 1,3-butadiene and polymers of styrene with at least one of isoprene and 1,3-butadiene monomers.

11. The rubber composition of claim 9 wherein said functionalized diene-based elastomers are comprised of at least one of cis 1,4-polybutadiene, styrene/butadiene and polyisoprene elastomers which contain vinyl 1,2-pendent groups from the polybutadiene or isoprene portion of the elastomers available to react with the said functional groups to form pendent functional groups on the elastomer's polymer chain.

12. The rubber composition of claim 9 said alkyl group of said functional groups are methyl groups.

13. The rubber composition of claim 9 wherein the functionalized elastomer is an end-chain functionalized elastomer.

14. The rubber composition of claim 9 wherein the functionalized elastomer is an in-chain functionalized elastomer with at least one of said functional groups attached to the elastomer chain through a thioether group.

15. A tire having at least one component comprised of the rubber composition of claim 9.

16. A tire having at least one component comprised of the rubber composition of clam 12.

17. A tire having at least one component comprised of the rubber composition of claim 13.

18. A tire having at least one component comprised of the rubber composition of clam 14.
